(19) United States
(12) Patent Application Publication
(10) Pub. No.: US 2022/0340109 A1
(43) Pub. Date: Oct. 27, 2022

(54) BRAKE CONTROL SYSTEM

(71) Applicant: Airbus Operations Limited, Bristol (GB)

(72) Inventors: Ashley BIDMEAD, Bristol (GB); Florian BECHER, Bristol (GB); Andrew HEBBORN, Bristol (GB)

(21) Appl. No.: 17/726,763

(22) Filed: Apr. 22, 2022

(30) Foreign Application Priority Data
Apr. 23, 2021 (GB) 2105791.4

(51) Int. Cl. B60T 8/17; B60T 8/171

(52) U.S. Cl. CPC B60T 8/1703; B60T 8/171; B60T 2201/10

(57) ABSTRACT

A brake control system for an aircraft is disclosed having a plurality of brake actuators. Each brake actuator includes a braked state imparting an unknown braking torque, and a parked state imparting a known braking torque. The system includes a controller to control the states of the brake actuators. In response to a parking signal, when at least one of the brake actuators is in the braked or parked state, the controller performs a parking procedure comprising maintaining a first brake actuator in the braked or parked state whilst changing the state of a second brake actuator from the braked state to the parked state. Also disclosed is an aircraft including the brake control system, a method of controlling a brake system for an aircraft, and a non-transitory computer readable storage medium.

### CROSS RELATED APPLICATION

This application claims priority to United Kingdom Patent Application GB2105791.4, filed Apr. 23, 2021, the entire contents of which is hereby incorporated by reference.

### TECHNICAL FIELD

The present invention relates to a brake control system for an aircraft, an aircraft comprising the brake control system, a method of controlling a brake system of an aircraft, and a non-transitory computer readable storage medium.

### BACKGROUND

Modern aircraft, such as helicopters, are fitted with brakes that can be arranged in a parked state. The parked state may be requested at a time when the brakes are already applied but the braking torque and/or brake position is unknown. In this instance, the brakes must first be released and then reapplied in order to place the brakes in the parked state, which can result in unwanted movement of the aircraft.

The present invention mitigates the above-mentioned problem and accordingly may provide an improved brake control system for an aircraft.

### SUMMARY

A first aspect of the present invention provides a brake control system for an aircraft having a plurality of brake actuators, wherein: each brake actuator comprises a braked state imparting an unknown braking torque, and a parked state imparting a known braking torque; the brake control system comprises a controller configured to control the states of the plurality of brake actuators; and in response to a parking signal when at least one of the brake actuators is in the braked or parked state, the controller performs a parking procedure comprising maintaining a first brake actuator in the braked or parked state whilst changing the state of a second brake actuator from the braked state to the parked state. It will be understood that, in the braked state, by imparting an unknown braking torque, the, or each, actuator imparts an unknown braking torque that is non-zero. Similarly, in the parked state, the, or each, actuator imparts a known braking torque that is non-zero.

Optionally, the controller is configured to perform the parking procedure, in response to the parking signal when the plurality of brake actuators are in the braked state.

Optionally, each brake actuator comprises a reference state imparting a known braking torque that is lower than the known braking torque in the parked state, and the parking procedure comprises maintaining the first brake actuator in the braked or parked state whilst changing the second brake actuator from the braked state to the reference state, and from the reference state to the parked state. Optionally, the reference state is a released state imparting no braking torque. That is, the released state is an unbraked state. Optionally, the parking procedure comprises causing initial contact between braking surfaces of the brake, caused by the second brake actuator, when changing the second brake actuator from the released state to the parked state. Optionally, one of the braking surfaces of the brake is a surface comprised by a rotor and another of the braking surfaces is a surface comprised by a stator. Optionally, the controller is configured to control a relative position between the rotor and stator when changing the second brake actuator from the released state to the parked state. Optionally, the second brake actuator is comprised by a single-actuator brake, such that when the second brake actuator is arranged in the released state, a stator and a rotor of the single-actuator brake are disengaged.

Optionally, the first brake actuator and the second brake actuator are comprised by a first brake of the aircraft. The first brake is therefore a multiple-actuator brake.

Optionally, the first brake actuator is comprised by a first brake of the aircraft and the second brake actuator is comprised by a second brake of the aircraft. Optionally, the first brake and/or the second brake is a single-actuator brake. Optionally, the first brake and/or the second brake is a multiple-actuator brake.

Optionally, at least one brake actuator comprises an actuatable piston. Optionally, each brake actuator comprises an actuatable piston.

Optionally, the maintaining of the parking procedure comprises maintaining a plurality of first brake actuators in the braked or parked state whilst changing the state of the second brake actuator from the braked state to the parked state. Optionally, each first brake actuator is comprised by a different brake of the aircraft. Optionally, at least one brake is a multiple-actuator brake.

Optionally, the changing of the parking procedure comprises simultaneously or sequentially changing the state of a plurality of second brake actuators from the braked state to the parked state. Optionally, each second brake actuator is comprised by a different brake of the aircraft. Optionally, at least one brake is a multiple-actuator brake.

A second aspect of the present invention provides an aircraft comprising the brake control system according to the first aspect.

Optionally, the aircraft is a vertical and/or short take-off and landing (V/STOL) aircraft. Optionally, the aircraft is a vertical take-off and landing (VTOL) aircraft. Optionally, the aircraft is a fixed-wing aircraft. Optionally, the aircraft is a rotary-wing aircraft. Optionally, the aircraft is a helicopter. Optionally, the aircraft is an unmanned aerial vehicle (UAV).

A third aspect of the present invention provides a method of controlling a brake system for an aircraft having a plurality of brake actuators, wherein each brake actuator comprises a braked state imparting an unknown braking torque, and a parked state imparting a known braking torque, the method comprises: controlling the states of the plurality of brake actuators; and in response to a parking signal when at least one of the plurality of brake actuators is in the braked or parked state, performing a parking procedure comprising maintaining a first brake actuator in the braked or parked state whilst changing the state of a second brake actuator from the braked state to the parked state. It will be understood that, in the braked state, by imparting an unknown braking torque, the, or each, actuator imparts an unknown braking torque that is non-zero. Similarly, in the parked state, the, or each, actuator imparts a known braking torque that is non-zero.

A fourth aspect of the present invention provides a non-transitory computer readable storage medium comprising a set of computer-readable instructions stored thereon, which, when executed by a controller of a brake control system for an aircraft having a plurality of brake actuators, wherein each brake actuator comprises a braked state imparting an unknown braking torque, and a parked state imparting a known braking torque, causes the controller to: control the states of the plurality of brake actuators, and in response to a parking signal when at least one of the plurality of brake actuators is in the braked or parked state, perform a parking procedure comprising maintaining a first brake actuator in the braked or parked state whilst changing the state of a second brake actuator from the braked state to the parked state. It will be understood that, in the braked state, by imparting an unknown braking torque, the, or each, actuator imparts an unknown braking torque that is non-zero. Similarly, in the parked state, the, or each, actuator imparts a known braking torque that is non-zero.

A fifth aspect of the present invention provides a braking system for an aircraft, the braking system comprising two or more brake torque applicators and a controller configured to cause one or more of the brake torque applicators to be arranged away from a braking arrangement, in which an unknown braking torque is applied, and to a parked arrangement, in which a known braking torque is applied, while the aircraft is braked by another brake torque applicator of the braking system. It will be understood that, in the braking arrangement, by imparting an unknown braking torque, the, or each, torque applicator imparts an unknown braking torque that is non-zero. Similarly, in the parked state, the, or each, actuator imparts a known braking torque that is non-zero.

A sixth aspect of the present invention provides an avionics system comprising the brake control system according to the first aspect.

The above aspects of the present invention provide for improved brake control of an aircraft. The above aspects of the present invention provide for improved management of the brake to enhance a function of the aircraft.

Any optional feature(s) of any one aspect of the present invention may be equally applied to any other aspect(s) of the present invention, where appropriate.

### BRIEF DESCRIPTION OF THE DRAWINGS

Embodiments of the invention will now be described, by way of example only, with reference to the accompanying drawings, in which:

FIG. 1 is a schematic diagram showing a side view of an aircraft according to an embodiment;

FIG. 2 is a schematic diagram showing an avionics system according to an embodiment;

FIG. 3 is a flow diagram illustrating a method of controlling a brake system for an aircraft according to an embodiment; and

FIG. 4 is a schematic illustration of a set of computer readable instructions within a non-transitory computer-readable storage medium according to an embodiment.

### DETAILED DESCRIPTION

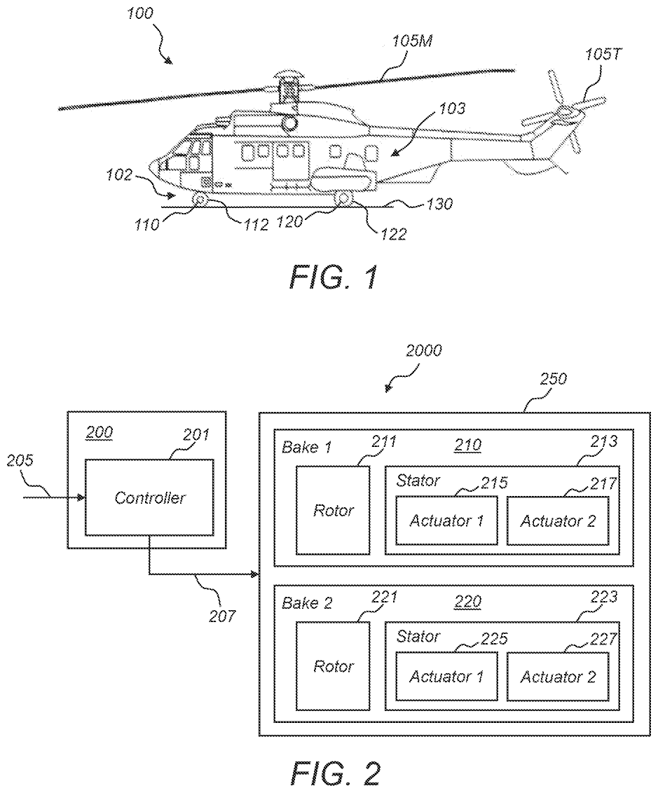

FIG. 1 is a side view of an aircraft 100. In this embodiment, the aircraft is a helicopter, which is an example of a rotary-wing aircraft capable of landing vertically and independently of a ground speed.

The aircraft 100 comprises a propulsion device, in the form of a main rotor 105M, and an angular control device, in the form of a tail rotor 105T. The propulsion device is arranged to provide a lift force and propel the aircraft in a forward and backward direction according to a forward thrust and a backward thrust, respectively. The angular control device is arranged to control a yawing moment of the aircraft about a centre of gravity of the aircraft so that the aircraft can be steered about a vertical axis of the aircraft according to a sideways thrust produced by the angular control device.

In this embodiment, the main rotor 105M and tail rotor 105T are powered by a power unit, in the form of an engine 103. In other embodiments, the power unit comprises an electrical motor, wherein the motor electrical is optionally powered by a battery.

The aircraft 100 comprises a landing gear 102 which supports the aircraft when the aircraft is on a landing surface 130, such as a helipad, and controls movement of the aircraft during ground manoeuvres such as landing and take-off. The landing gear comprises a set of wheels. Each wheel comprises a brake 110, 120 and a tyre 112, 122. In this embodiment, each tyre 112, 122 is a pneumatic tyre and filled with air under pressure. In this embodiment, the landing gear comprises two front tyres 112 and two front brakes 110, and two rear tyres 122 and two rear brakes 120. One of the rear brakes is a starboard-side brake on a starboard side of the aircraft and the other one of the rear brakes is a port-side brake on a port side of the aircraft. In other embodiments, a different number of wheels, tyres and/or brakes can be used.

Each brake 110, 120 comprises a stator and a rotor. The stator comprises a calliper, and the rotor comprises a disc. The calliper is to exert a friction force on the disc to resist rotation of the disc. The brakes can be manually controlled by a flight crew (for example, a pilot) using a foot brake. The brakes can also be controlled by a park function. In this embodiment, the flight crew initiate the park function. In other embodiments, the park function can be initiated automatically according to an input from a sensor, such as a sensor indicating a proximity of the aircraft to the landing surface 130.

In the view shown in FIG. 1, the aircraft 100 is on the landing surface 130. In this embodiment, the landing surface is restricted insofar as the landing surface has a length that is less than a span of the main rotor 105M. In other embodiments, the landing surface can have a length, such as a diameter, that is less than double a span of the main rotor 105M.

FIG. 2 illustrates an avionics system 2000 according to an embodiment. The avionics system comprises a brake control system 200 and a brake system 250. In some embodiments, the avionics system comprises a memory for storing information about the brake control system and/or the brake system. In this embodiment, the memory is omitted from the avionics system.

The brake control system 200 is for controlling two brakes 210, 220 of an aircraft, such as the brakes 110, 120 of the aircraft 100 described in relation to the embodiment of FIG. 1. In other embodiments, the brake control system controls a different number of brakes other than two brakes. The brake control system is to provide improved park braking of the aircraft by limiting rolling movement of the aircraft when performing a parking procedure. The brake control system is therefore a braking system for an aircraft.

The brake control system 200 comprises a controller 201. In some embodiments, the controller is a processor or one or more processors. The controller is configured to control states of four brake actuators 215, 217, 225, 227 of the aircraft 100. In other embodiments, the controller is configured to control states of a plurality of brake actuators of the aircraft. In this embodiment, each brake 210, 220 is a multiple-actuator brake, wherein each brake comprises a plurality of brake actuators. In other embodiments, at least one brake can be a single-actuator brake, wherein each brake comprises a single brake actuator.

In this embodiment, the controller 201 is activated by a command from the flight crew, wherein the command is referred to as a parking signal 205. The command is activated when the aircraft 100 is on the ground. The command indicates that a park brake event is required so that the aircraft can be held stationary on the ground by at least one brake. In some embodiments, the aircraft may automatically detect that the park brake event is required. In this embodiment, the controller sends an output signal 207 to the brake 210 to cause application of a braking torque of the brake.

Each brake actuator 215, 217, 225, 227 comprises a braked state imparting an unknown braking torque, and a parked state imparting a known braking torque. It will be understood that, in the braked state, by imparting an unknown braking torque, each actuator 215, 217, 225, 227 imparts an unknown braking torque that is non-zero. Similarly, in the parked state, the, or each, actuator imparts a known braking torque that is non-zero. In response to the parking signal 205, when at least one of the brake actuators is in the braked state or the parked state, the controller performs a parking procedure. The parking procedure comprises sending instructions to maintain a first brake actuator in the braked or parked state, whilst changing the state of a second brake actuator from the braked state to the parked state. In this embodiment, the controller issues the instructions in the form of the output signal 207 to the brake system 250 to cause the change of states of the brake actuators.

Put in another way, the controller 201 is configured to cause one or more brake torque applicators to be arranged away from a braking arrangement, in which an unknown braking torque is applied, and to a parked arrangement, in which a known braking torque is applied, while the aircraft 100 is braked by another brake torque applicator of the braking system. Advantageously, a chance of movement of the aircraft is reduced while the aircraft is parked on the ground.

The first brake actuator can correspond to any one of the brake actuators 215, 217, 225, 227 on any one of the brakes 210, 220. The second brake actuator can correspond to another other one (or more than one) of the brake actuators (other than the first brake actuator) on any one of the brakes. That is, the second brake actuator can correspond to another brake actuator on the same brake 210, 220 or another brake actuator on a different brake. If one brake actuator is exerting a braking torque, another brake actuator can be changed from the braked state to the parked state. This reduces or avoids a chance of rolling movement of the aircraft 100.

In one example, the first brake actuator 215 corresponds to “Actuator 1” of the first brake 210 (shown as “Brake 1” in FIG. 2), and the second brake actuator 217 corresponds to “Actuator 2” of the first brake. In this example, the first and second brake actuators are comprised by the same brake because the first brake is a multiple-actuator brake. In response to the parking signal 205, when Actuator 1 of the first brake is in the braked state or parked state, the controller 201 performs the parking procedure. Here, the parking procedure comprises maintaining Actuator 1 of the first brake in the braked or parked state, whilst changing the state of Actuator 2 of the first brake from the braked state to the parked state.

In another example, the first brake actuator 225 corresponds to “Actuator 1” of the second brake 220 (shown as “Brake 2” in FIG. 2), and the second brake actuator 217 corresponds to Actuator 1 of the first brake 210. In this example, the first and second brake actuators are comprised by different brakes. Although, in this embodiment, Brake 1 and Brake 2 are multiple-actuator brakes, in other embodiments, Brake 1 and Brake 2 can be single-actuator brakes. In this example, in response to the parking signal 205, when Actuator 1 of the second brake 220 is in the braked state or parked state, the controller 201 performs the parking procedure. Here, the parking procedure comprises maintaining Actuator 1 of the second brake 220 in the braked or parked state, whilst changing the state of Actuator 1 of the first brake 210 from the braked state to the parked state.

In some examples of the parking procedure, the first brake actuator 215 may be maintained in the braked or parked state, whilst changing the state of each other one of the second brake actuators, comprising the remaining brake actuators 217, 225, 227 shown in FIG. 2, from the braked state to the parked state. The changing of the state of each other one of the second brake actuators from the braked state to the parked state can be performed simultaneously or sequentially. For example, the first brake actuator 227 can correspond to “Actuator 2” of the second brake 220. In response to the parking signal 205, when Actuator 2 of the second brake 220 is in the braked state or parked state, the controller 201 performs the parking procedure. Here, the parking procedure comprises maintaining Actuator 2 of the second brake 220 in the braked or parked state, whilst changing the state of each of Actuator 1 and Actuator 2 of the first brake 210 and Actuator 1 of the second brake 220 from the braked state to the parked state simultaneously or sequentially.

In some examples of the parking procedure, the first brake actuator may comprise a plurality of brake actuators 215, 217, 225, 227. The plurality of brake actuators may be held in the braked or parked state simultaneously or sequentially, whilst changing the state of each other one of the second brake actuators.

In some examples of the parking procedure, the first brake actuator may comprise multiple brake actuators 215, 217, 225, 227. In some examples, the first brake actuator may comprise a different brake actuator each time another brake actuator changes state from the braked state to the parked state in the parking procedure.

Each of the two brakes 210, 220 comprises a rotor 211, 221 in the form of a brake disc that is configured to rotate with a wheel, and a stator 213, 223 comprising a brake calliper that is configured to be fixed with respect to a rotation of the wheel. Each of the rotor and stator comprise a braking surface, such that movement of the stator towards the rotor 211 is configured to cause contact between the braking surfaces and impart the clamping torque of the brake. In this embodiment, the brake calliper comprises two actuatable pistons, wherein each actuator 215, 217, 225, 227 comprises an actuatable piston.

In this embodiment, the braking torque of the brake 210, 220 is known based on a detected position of the rotor 211, 221 relative to the stator 213, 223. The stator, in the form of a brake calliper, comprises an actuatable piston that moves a brake pad towards the rotor in the form of a brake disc. When contact is made between the braking surfaces of the stator and rotor (for example, between a surface of the brake pad and a surface of the brake disc), an indication of contact is provided to the controller 201, for example an increase of current. The indication of contact between the braking surfaces represents a reference point of the brake. Application of the brake from the reference point results in a known braking torque.

In this embodiment, each brake actuator 215, 217, 225, 227 comprises a reference state imparting a known braking torque that is lower than the known braking torque in the parked state. In some embodiments, the known braking torque in the parked state may correspond to a maximum braking torque of the brake 210, 220 or a braking torque that is different to the maximum braking torque of the brake. The parking procedure comprises maintaining the first brake actuator in the braked or parked state whilst changing the second brake actuator from the braked state to the reference state, and from the reference state to the parked state. In this embodiment, the reference state is a released state imparting no braking torque. In the released state, the brake actuator is retracted such that no braking torque is applied by that brake actuator. That is, in this embodiment, the brake actuator is disengaged in the released state. In other embodiments, the reference state can be a state imparting braking torque that is greater than zero.

Advantageously, the parking procedure protects against misbehaviour of the electrical system so that a ground position of the aircraft 100 is uncompromised while sufficient braking torque is applied to at least one brake to hold the ground position of the aircraft or at least minimise rolling movement to the aircraft. The parking procedure avoids complete loss or braking torque to avoid the rolling movement to the aircraft.

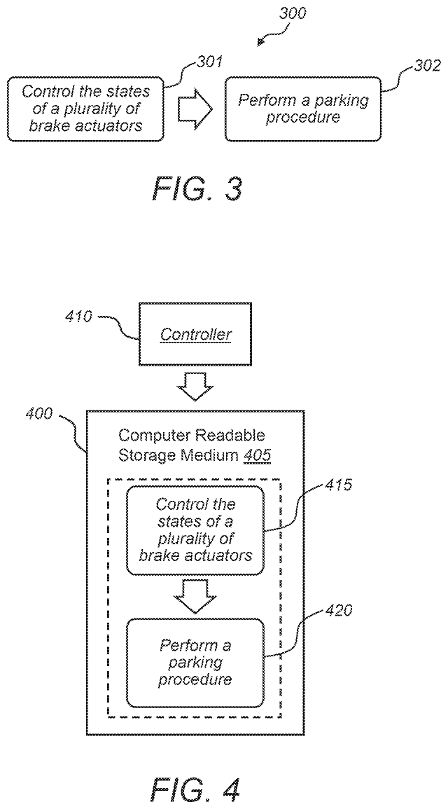

FIG. 3 is a flow diagram illustrating a method 300 of controlling a brake system for an aircraft, such as the aircraft 100 described above with reference to FIG. 1. The brake system comprises a plurality of brake actuators, wherein each brake actuator comprises a braked state imparting an unknown braking torque, and a parked state imparting a known braking torque.

At block 301, the method 300 comprises controlling (for example by a controller) the states of the plurality of brake actuators. At block 302, the method 300 comprises, in response to a parking signal when at least one of the plurality of brake actuators is in the braked or parked state, performing (for example by the controller) a parking procedure. The parking procedure comprises maintaining a first brake actuator in the braked or parked state whilst changing the state of a second brake actuator from the braked state to the parked state.

A schematic illustration of a set of computer readable instructions 400 within a non-transitory computer-readable storage medium 405 according to an embodiment is shown in FIG. 4. The set of computer readable instructions are executable by a controller 410 of a brake control system for an aircraft, for example the controller 201 of the brake control system 200 described above in relation to FIG. 2. The brake control system is for an aircraft having a plurality of brake actuators, wherein each brake actuator comprises a braked state imparting an unknown braking torque, and a parked state imparting a known braking torque. When executed, the instructions cause the controller to control 415 the states of the plurality of brake actuators. In response to a parking signal when at least one of the plurality of brake actuators is in the braked or parked state, the instructions cause the controller to perform 420 a parking procedure. The parking procedure comprises maintaining a first brake actuator in the braked or parked state whilst changing the state of a second brake actuator from the braked state to the parked state.

In the embodiment of FIG. 1, the brakes 110, 120 are electromechanically actuatable, such that relative movement of the calliper with respect to the disc is achieved by electrical energy to exert the braking torque. In other embodiments, the brake or brakes can be hydraulically actuatable such that relative movement of the calliper with respect to the disc is achieved by hydraulic pressure to exert a braking torque, which is a clamping force.

In some embodiments, the brake control system 200 described above with reference to FIG. 2 can be installed in an aircraft, such as the aircraft 100 described above with reference to FIG. 1. Although a plurality of actuators is described in the embodiment of FIG. 2, in other embodiments, each brake optionally comprises a single brake actuator.

Advantageously, features of the embodiments described herein provide improved brake control of an aircraft. Advantageously, an improved parking procedure is provided. The improved brake control reduces a tendency for an aircraft to roll during management of a brake or brakes during parking.

It is to be noted that the term “or” as used herein is to be interpreted to mean “and/or”, unless expressly stated otherwise.

The above embodiments are to be understood as non-limiting illustrative examples of how the present invention, and aspects of the present invention, can be implemented. Further examples of the present invention are envisaged. It is to be understood that any feature described in relation to any one embodiment can be used alone, or in combination with other features described, and may also be used in combination with one or more features of any other of the embodiments, or any combination of any other of the embodiments. Furthermore, equivalents and modifications not described above may also be employed without departing from the scope of the present invention, which is defined in the accompanying claims.

1. A brake control system for an aircraft having a plurality of brake actuators, wherein:
each brake actuator comprises a braked state imparting an unknown braking torque, and a parked state imparting a known braking torque;
the brake control system comprises a controller configured to control the states of the plurality of brake actuators; and
in response to a parking signal when at least one of the brake actuators is in the braked state or parked state, the controller performs a parking procedure comprising maintaining a first brake actuator in the braked or parked state whilst changing the state of a second brake actuator from the braked state to the parked state.

2. The brake control system according to claim 1, wherein each brake actuator comprises a reference state imparting a known braking torque that is lower than the known braking torque in the parked state, and the parking procedure comprises maintaining the first brake actuator in the braked or parked state whilst changing the second brake actuator from the braked state to the reference state, and from the reference state to the parked state.

3. The brake control system according to claim 2, wherein the reference state is a released state imparting no braking torque.

4. The brake control system according to claim 1, wherein the first brake actuator and the second brake actuator are comprised by a first brake of the aircraft.

5. The brake control system according to claim 1, wherein the first brake actuator is comprised by a first brake of the aircraft and the second brake actuator is comprised by a second brake of the aircraft.

6. The brake control system according to claim 1, wherein at least one brake actuator comprises an actuatable piston.

7. The brake control system according to claim 1, wherein the maintaining of the parking procedure comprises maintaining a plurality of first brake actuators in the braked or parked state whilst changing the state of the second brake actuator from the braked state to the parked state.

8. The brake control system according to claim 7, wherein each first brake actuator is comprised by a different brake of the aircraft.

9. The brake control system according to claim 1, wherein the changing of the parking procedure comprises simultaneously changing the state of a plurality of second brake actuators from the braked state to the parked state.

10. The brake control system according to claim 1, wherein the changing of the parking procedure comprises sequentially changing the state of a plurality of second brake actuators from the braked state to the parked state.

11. The brake control system according to claim 9, wherein each second brake actuator is comprised by a different brake of the aircraft.

12. An aircraft comprising the brake control system according to claim 1.

13. A method of controlling a brake system for an aircraft having a plurality of brake actuators, wherein each brake actuator comprises a braked state imparting an unknown braking torque, and a parked state imparting a known braking torque, the method comprises:
controlling the states of the plurality of brake actuators; and
in response to a parking signal when at least one of the plurality of brake actuators is in the braked or parked state, performing a parking procedure comprising maintaining a first brake actuator in the braked or parked state whilst changing the state of a second brake actuator from the braked state to the parked state.

14. The method according to claim 13, wherein each brake actuator comprises a reference state imparting a known braking torque that is lower than the known braking torque in the parked state, and the parking procedure comprises maintaining the first brake actuator in the braked or parked state whilst changing the state of the second brake actuator from the braked state to the reference state, and from the reference state to the parked state, wherein the reference state is a released state imparting no braking torque.

15. A non-transitory computer readable storage medium comprising a set of computer-readable instructions stored thereon, which, when executed by a controller of a brake control system for an aircraft having a plurality of brake actuators, wherein each brake actuator comprises a braked state imparting an unknown braking torque, and a parked state imparting a known braking torque, causes the controller to:
control the states of the plurality of brake actuators, and
in response to a parking signal when at least one of the plurality of brake actuators is in the braked or parked state, perform a parking procedure comprising maintaining a first brake actuator in the braked or parked state whilst changing the state of a second brake actuator from the braked state to the parked state.

16. A braking system for an aircraft, the braking system comprising two or more brake torque applicators and a controller configured to cause one or more of the brake torque applicators to be arranged away from a braking arrangement, in which an unknown braking torque is applied, and to a parked arrangement, in which a known braking torque is applied, while the aircraft is braked by another brake torque applicator of the braking system.
